(19) United States
(12) Patent Application Publication
(10) Pub. No.: US 2021/0165872 A1
(43) Pub. Date: Jun. 3, 2021

(54) INFORMATION PROCESSING DEVICE, INFORMATION PROCESSING METHOD, PROGRAM, AND INFORMATION PROCESSING SYSTEM

(71) Applicant: Sony Corporation, Tokyo (JP)

(72) Inventors: Yasuyuki Kato, Tokyo (JP); Kaoru Matsunaga, Tokyo (JP); Daisuke Sasaki, Tokyo (JP)

(21) Appl. No.: 17/046,339

(22) PCT Filed: May 10, 2019
(86) PCT No.: PCT/JP2019/018677

§ 371 Date: Oct. 9, 2020

(30) Foreign Application Priority Data
May 24, 2018 (JP) 2018-099297

(51) Int. Cl. G06F 21/45; G07C 9/00

(52) U.S. Cl. CPC G06F 21/45; G07C 9/00912

(57) ABSTRACT

An information processing device, method, program, and system that receives an item in a delivery locker on behalf of a user and delivers it safely to a user are disclosed. The information processing device generates different passwords for one item, the different passwords being passwords for receiving the item from a delivery locker. A delivery locker manager sets, on a delivery locker, different passwords for one item, the different passwords being passwords for receiving the item. A communication unit transmits a second password that is different from a first password for a user for receiving an item in a delivery locker to a proxy transporter that performs proxy transportation including receiving the item in the delivery locker and delivering the item to the user. The disclosed technology can be applied to, for example, a system that provides a proxy transportation service.

### TECHNICAL FIELD

The present technology relates to an information processing device, an information processing method, a program, and an information processing system, and particularly, to an information processing device, an information processing method, a program, and an information processing system which are suitable to be used when a service of receiving an item from a delivery locker on behalf of a user and delivering the item to the user is realized.

### BACKGROUND ART

Recently, a delivery locker by which a user can receive an item that is to be delivered to the user at a time convenient for the user has become popular.

In addition, a conventional technology for using analog type coin lockers installed in stations and the like as delivery lockers has been proposed (refer to PTL 1, for example).

### CITATION LIST

### Patent Literature

[PTL 1]
JP 2015-232801A

### SUMMARY

### Technical Problem

However, there are cases in which a user has difficulty receiving an item from a delivery locker and taking the item home because the user is so busy that he/she has no time, the weather is bad, the user has a lot of luggage, the delivery locker is far away from home, and the like.

An object of the present technology devised in view of such circumstances is to realize a service of receiving an item from a delivery locker on behalf of a user and delivering the item to the user safely.

### Solution to Problem

An information processing device of a first aspect of the present technology includes a password generator configured to generate a plurality of different passwords for one item, the different passwords being passwords for receiving the item from a delivery locker.

An information processing method of the first aspect of the present technology includes, by an information processing device, generating a plurality of different passwords for one item, the different passwords being passwords for receiving the item from a delivery locker.

A program of the first aspect of the present technology causes a computer to execute processing of generating a plurality of different passwords for one item, the different passwords being passwords for receiving the item from a delivery locker.

An information processing device of a second aspect of the present technology includes a delivery locker manager configured to set, on a delivery locker, a plurality of different passwords for one item, the different passwords being passwords for receiving the item.

An information processing method of the second aspect of the present technology includes, by an information processing device, setting, on a delivery locker, a plurality of different passwords for one item, the different passwords being passwords for receiving the item.

A program of the second aspect of the present technology causes a computer to execute processing of setting, on a delivery locker, a plurality of different passwords for one item, the different passwords being passwords for receiving the item.

An information processing device of a third aspect of the present technology includes a communication unit configured to transmit a second password that is different from a first password for a user to receive an item in a delivery locker to a proxy transporter that performs proxy transportation including receiving the item in the delivery locker and delivering the item to the user.

An information processing method of the third aspect of the present technology includes, by an information processing device, transmitting a second password that is different from a first password for a user to receive an item in a delivery locker to a proxy transporter that performs proxy transportation including receiving the item in the delivery locker and delivering the item to the user.

A program of the third aspect of the present technology causes a computer to execute processing of transmitting a second password that is different from a first password for a user to receive an item in a delivery locker to a proxy transporter that performs proxy transportation including receiving the item in the delivery locker and delivering the item to the user.

An information processing system of a fourth aspect of the present technology includes: a password generator configured to generate a first password for a user to receive an item in a delivery locker, and a second password for a proxy transporter that performs proxy transportation including receiving the item in the delivery locker and delivering the item to the user; a delivery locker manager configured to set the first password and the second password on the delivery locker; and a communication unit configured to transmit the second password to the proxy transporter.

In the first aspect of the present technology, a plurality of different passwords for receiving an item from the delivery locker are generated for one item.

In the second aspect of the present technology, a plurality of different passwords for receiving an item are set on the delivery locker for one item.

In the third aspect of the present technology, the second password different from the first password for a user to receive an item in a delivery locker is transmitted to a proxy transporter that performs proxy transportation including receiving the item in the delivery locker and delivering the item to the user.

In the fourth aspect of the present technology, the first password for a user to receive an item in a delivery locker, and the second password for a proxy transporter that performs proxy transportation including receiving the item in the delivery locker and delivering the item to the user are generated, the first password and the second password are set on the delivery locker, and the second password is transmitted to the proxy transporter.

### Advantageous Effects of Invention

According to the first to fourth aspects of the present technology, it is possible to realize the service of receiving an item in a delivery locker on behalf of a user and delivering the item to the user safely.

Meanwhile, the effects described herein are not necessarily limited and may be any effect described in the present disclosure.

### BRIEF DESCRIPTION OF DRAWINGS

FIG. 1 is a block diagram illustrating a first embodiment of a delivery system to which the present technology is applied.

FIG. 2 is a block diagram illustrating a configuration example of functions of a delivery company server.

FIG. 3 is a block diagram illustrating a configuration example of functions of a delivery locker server.

FIG. 4 is a block diagram illustrating a configuration example of functions of a proxy transportation server.

FIG. 5 is a flowchart for describing processing of the delivery company server.

FIG. 6 is a flowchart for describing processing of the delivery locker server.

FIG. 7 is a flowchart for describing processing of the proxy transportation server.

FIG. 8 is a sequence diagram illustrating a processing flow when a user requests proxy transportation by a proxy transportation company.

FIG. 9 is a sequence diagram illustrating a processing flow when a delivery company requests proxy transportation by the proxy transportation company.

FIG. 10 is a block diagram illustrating a second embodiment of a delivery system to which the present technology is applied.

FIG. 11 is a block diagram illustrating a third embodiment of a delivery system to which the present technology is applied.

FIG. 12 is a block diagram illustrating a fourth embodiment of a delivery system to which the present technology is applied.

FIG. 13 is a diagram illustrating a configuration example of a computer.

### DESCRIPTION OF EMBODIMENTS

Hereinafter, modes for embodying the present technology will be described.

Note that the description will be given in the following order.

### 1. Embodiments

### 2. Modified Examples

### 3. Others

### 1. EMBODIMENTS

<Configuration Example of Delivery System 1>

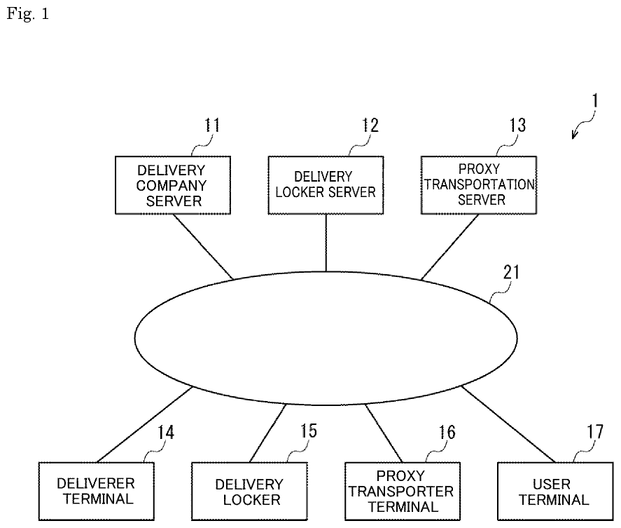

FIG. 1 is a block diagram illustrating a configuration example of a delivery system 1 to which the present disclosure is applied.

The delivery system 1 is a system that realizes delivery of an item to a user. Users of the delivery system 1 may include, for example, a user (requestor) that requests delivery of an item and a user (receiver) that is an item delivery destination and receives an item. A user who is a requestor and a user who is a receiver may be identical or different. In addition, a user may be any of a natural person and a juristic person.

The delivery system 1 includes a delivery company server 11, a delivery locker server 12, a proxy transportation server 13, a deliverer terminal 14, a delivery locker 15, a proxy transporter terminal 16, and a user terminal 17. The delivery company server 11, the delivery locker server 12, the proxy transportation server 13, the deliverer terminal 14, the delivery locker 15, the proxy transporter terminal 16, and the user terminal 17 are connected via a network 21.

Meanwhile, the network 21 may be configured as a single communication network or configured by combining a plurality of communication networks.

In addition, although FIG. 1 illustrates a single delivery company server 11, a single delivery locker server 12, a single proxy transportation server 13, a single deliverer terminal 14, a single delivery locker 15, a single proxy transporter terminal 16, and a single user terminal 17, the number of each component may be set to any number.

The delivery company server 11 is a server owned by a delivery company. The delivery company may be, for example, a company that provides a delivery service of receiving a request from a user and delivering an item to a place (e.g., home, an office, the delivery locker 15, a convenience store, or the like) designated by the user.

The delivery company server 11 performs various types of processing for providing the delivery service. For example, the delivery company server 11 performs processing such as reception of a request for item delivery, design and execution of a delivery plan, request for a task to a deliverer, management of item delivery states, provision of various types of information to delivery locker companies, proxy transportation companies, deliverers, proxy transporters, and users, and accounting.

Here, a deliverer may be, for example, a person who performs a delivery task of receiving a request from a delivery company and delivering an item to a place designated by a user. A proxy transporter may be, for example, a person who performs proxy transportation including receiving a request from a proxy transportation company, receiving an item in the delivery locker 15 and delivering the item to a user.

The delivery locker server 12 is a server owned by a delivery locker company. The delivery locker company may be, for example, a company that provides a delivery locker service using the delivery locker 15. The delivery locker 15 may be installed, for example, in stations, commercial facilities, multiple dwelling houses, and the like, includes one or more storage spaces, and temporarily stores an item addressed to a user in the storage spaces. A user can take an item out of (a storage space of) the delivery locker 15 and receive the item by inputting a password notified in advance.

The delivery locker server 12 performs various types of processing for providing the delivery locker service. For example, the delivery locker server 12 may perform processing such as management of the delivery locker 15, provision of various types of information to delivery companies, proxy transportation companies, deliverers, proxy transporters, and users, and accounting.

The proxy transportation server 13 is a server owned by a proxy transportation company. The proxy transportation company is a company that provides a proxy transportation service of receiving an item in the delivery locker 15 on behalf of a user and delivering the item to the user.

The proxy transportation server 13 performs various types of processing for providing the proxy transportation service. For example, the proxy transportation server 13 may perform processing such as reception of a proxy transportation request, design and executing a proxy transportation plan, request for a task to a proxy transporter, management of item delivery states, provision of various types of information to delivery companies, delivery locker companies, deliverers, proxy transporters, and users, and accounting.

The deliverer terminal 14 is a terminal owned by a deliverer. The deliverer terminal 14 may be configured, for example, as a smartphone, a tablet, or a portable information terminal such as a dedicated terminal provided by a delivery company. The deliverer terminal 14 is used for a deliverer to perform a task. For example, the deliverer terminal 14 may perform input/output of various types of information or perform transmission/reception of various types of information to/from the delivery company server 11 and the like via the network 21.

Meanwhile, a single deliverer may own a plurality of deliverer terminals 14.

The proxy transporter terminal 16 is a terminal owned by a proxy transporter. The proxy transporter terminal 16 may be configured, for example, as a smartphone, a tablet, or a portable information terminal such as a dedicated terminal provided by a proxy transportation company. The proxy transporter terminal 16 is used for a proxy transporter to perform a task. For example, the proxy transporter terminal 16 may perform input/output of various types of information and perform transmission/reception of various types of information to/from the proxy transportation server 13 and the like via the network 21.

Meanwhile, a single proxy transporter may own a plurality of proxy transporter terminals 16.

The user terminal 17 is a terminal owned by a user. The user terminal 17 may be configured, for example, as an information processing terminal such as a smartphone, a tablet, or a personal computer (PC). The user terminal 17 is used for a user to use services provided by the delivery system 1. For example, the user terminal 17 may perform input/output of various types of information or perform transmission/reception of various types of information to/from the delivery company server 11, the proxy transportation server 13, and the like via the network 21.

Meanwhile, a single user may own a plurality of user terminals 17.

<Configuration Example of Functions of Delivery Company Server 11>

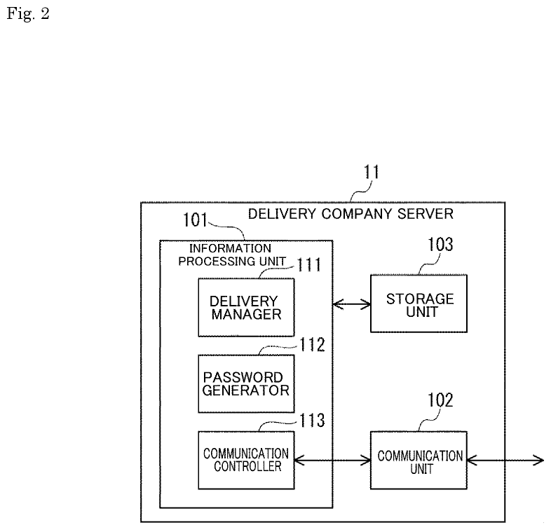

FIG. 2 is a block diagram illustrating a configuration example of a part of functions of the delivery company server 11. The delivery company server 11 includes an information processing unit 101, a communication unit 102, and a storage unit 103.

The information processing unit 101 performs various types of processing with respect to the delivery service. The information processing unit 101 includes a delivery manager 111, a password generator 112, and a communication controller 113.

The delivery manager 111 performs management of an item delivery task. For example, the delivery manager 111 may perform processing such as reception of an item delivery request, design and execution of a delivery plan, request for a task to a deliverer, management of item delivery states, provision of various types of information to delivery locker companies, proxy transportation companies, deliverers, proxy transporters, and users, and accounting.

The password generator 112 generates a password for a user and a proxy transporter to receive an item in the delivery locker 15.

The communication controller 113 performs control of communication processing of the communication unit 102. In addition, the communication controller 113 supplies information to be transmitted to other devices to the communication unit 102 or acquires information received from other devices from the communication unit 102.

The communication unit 102 performs communication with other devices to transmit/receive various types of information via the network 21.

Meanwhile, any method may be used as a communication method of the communication unit 102. In addition, the communication unit 102 may correspond to a plurality of communication methods.

The storage unit 103 stores programs, information, and the like used for management of the information processing unit 101.

<Configuration Example of Functions of Delivery Locker Server 12>

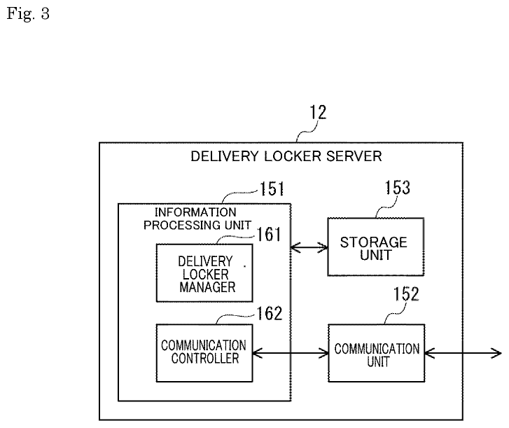

FIG. 3 is a block diagram illustrating a configuration example of a part of functions of the delivery locker server 12. The delivery locker server 12 includes an information processing unit 151, a communication unit 152, and a storage unit 153.

The information processing unit 151 performs various types of processing with respect to the delivery locker service. The information processing unit 151 includes a delivery locker manager 161 and a communication controller 162.

The delivery locker manager 161 performs management of tasks of the delivery service. For example, the delivery locker manager 161 may perform processing such as management of the delivery locker 15, provision of various types of information to delivery companies, proxy transportation companies, deliverers, proxy transporters, and users, and accounting. Management of the delivery locker 15 may include, for example, processing such as management of a usage and a use period of each storage space of the delivery locker 15, and setting and cancelation of a password for each storage space of the delivery locker 15.

The communication controller 162 performs control of communication processing of the communication unit 152. In addition, the communication controller 162 supplies information to be transmitted to other devices to the communication unit 152 or acquires information received from other devices from the communication unit 152.

The communication unit 152 performs communication with other devices to transmit/receive various types of information via the network 21.

Meanwhile, any method may be used as a communication method of the communication unit 152. In addition, the communication unit 152 may correspond to a plurality of communication methods.

The storage unit 153 stores programs, information, and the like used for processing of the information processing unit 151.

<Configuration Example of Functions of Proxy Transportation Server 13>

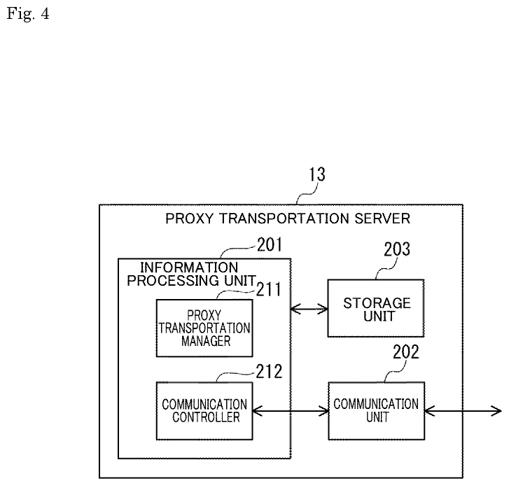

FIG. 4 is a block diagram illustrating a configuration example of a part of functions of the proxy transportation server 13. The proxy transportation server 13 includes an information processing unit 201, a communication unit 202, and a storage unit 203.

The information processing unit 201 performs various types of processing with respect to the proxy transportation service. The information processing unit 201 includes a proxy transportation manager 211 and a communication controller 212.

The proxy transportation manager 211 performs management of tasks of the proxy transportation service. For example, the proxy transportation manager 211 may perform processing such as reception of a proxy transportation request, design and executing a proxy transportation plan, request for a task to a proxy transporter, management of item delivery states, provision of various types of information to delivery companies, delivery locker companies, deliverers, proxy transporters, and users, and accounting.

The communication controller 212 performs control of communication processing of the communication unit 202. In addition, the communication controller 212 supplies information to be transmitted to other devices to the communication unit 202 or acquires information received from other devices from the communication unit 202.

The communication unit 202 performs communication with other device to transmit/receive various types of information via the network 21.

Meanwhile, any method may be used as a communication method of the communication unit 202. In addition, the communication unit 202 may be compatible with a plurality of communication methods.

The storage unit 203 stores programs, information, and the like used for management of the information processing unit 201.

Meanwhile, description of the network 21 when components of the delivery system 1 perform communication via the network 21 will be omitted below. For example, when the communication unit 102 of the delivery company server 11 communicates with the communication unit 152 of the delivery locker server 12 via the network 21, this is simply referred to as communication between the communication unit 102 and the communication unit 152.

<Processing of Delivery System 1>

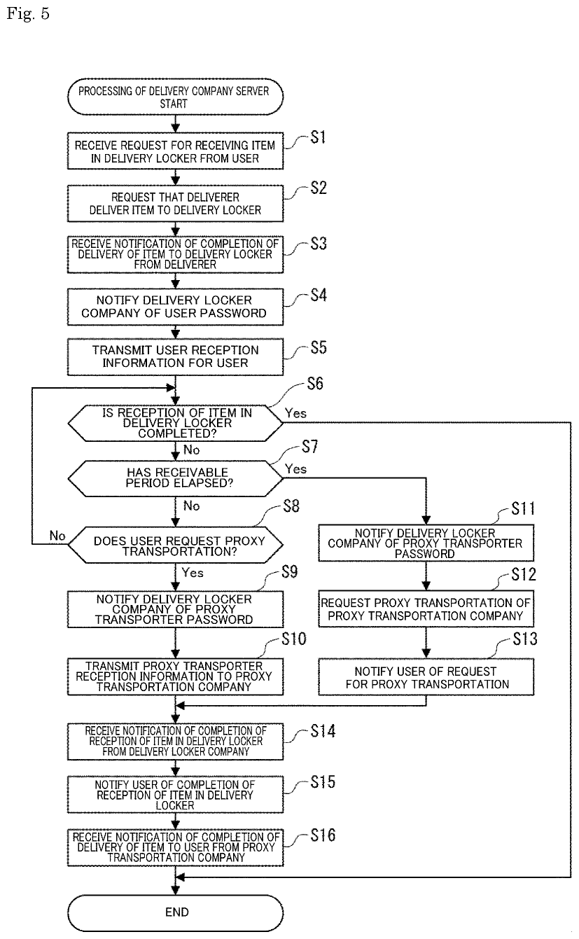

Next, processing of the delivery system 1 will be described with reference to FIG. 5 to FIG. 9. Specifically, processing when a user receives an item delivered to him/her using the delivery locker 15 will be described.

<Processing of Delivery Company Server 11>

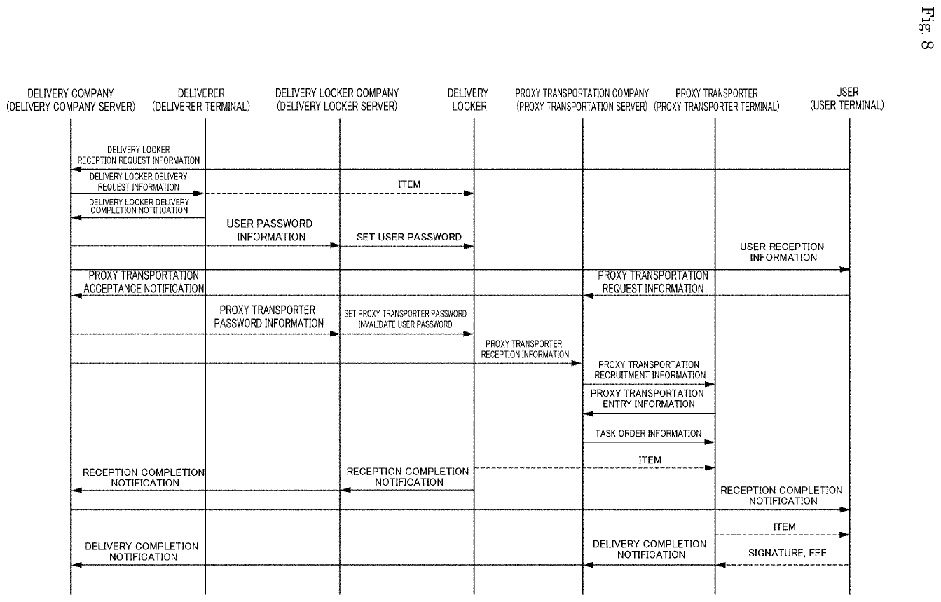

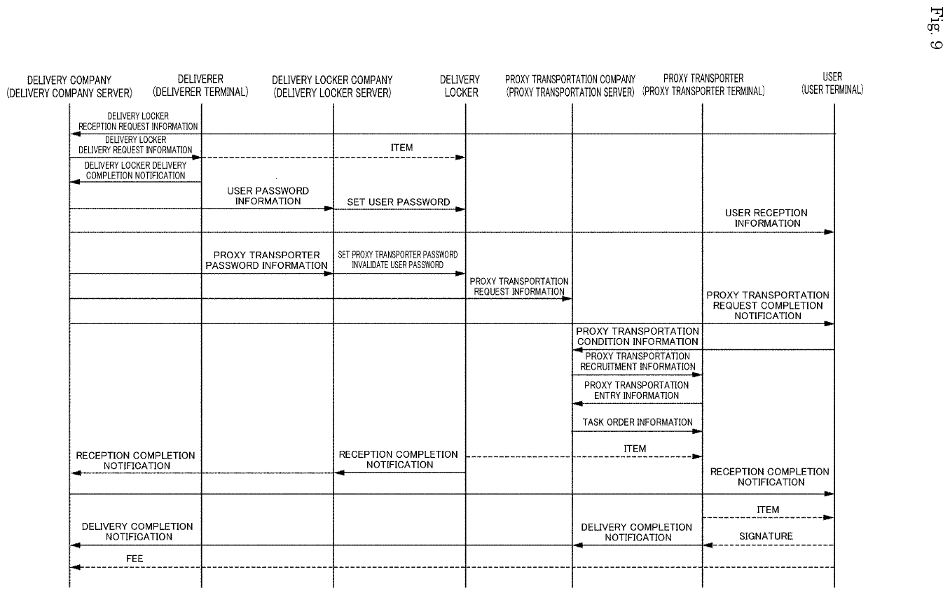

First, processing of the delivery company server 11 will be described with reference to a flowchart of FIG. 5 and sequence diagrams of FIG. 8 and FIG. 9. Meanwhile, FIG. 8 is a sequence diagram illustrating a processing flow when a user requests proxy transportation by a proxy transportation company. FIG. 9 is a sequence diagram illustrating a processing flow when a delivery company requests proxy transportation by the proxy transportation company.

In step S1, the delivery company server 11 receives a request for reception of an item in the delivery lockers 15 from a user.

For example, when the user requests that the delivery company receives the item in the delivery locker 15, the user transmits delivery locker reception request information to the delivery company server 11 using the user terminal 17, as illustrated in FIG. 8 or FIG. 9. The delivery locker reception request information may include, for example, an item ID for identifying the item that is a target, and the position of the delivery locker 15 from which the item is desired to be received.

The communication unit 102 of the delivery company server 11 receives the delivery locker reception request information and provides it to the communication controller 113.

In step S2, the delivery company server 11 requests that a deliverer deliver the item to the delivery locker 15.

Specifically, the delivery manager 111 generates delivery locker delivery request information for requesting that the deliverer deliver the item to the delivery locker 15. The delivery locker delivery request information may include, for example, the item ID of the item that is a target and a locker ID for identifying the delivery locker 15 that is a delivery destination.

The communication unit 102 transmits the delivery locker delivery request information to the deliverer terminal 14 of the deliverer taking charge of delivery under the control of the communication controller 113.

In step S3, the delivery company server 11 receives a notification of completion of item delivery to the delivery locker 15 from the deliverer.

For example, the deliverer may deliver the designated item to the designated delivery locker 15 and store the item in a storage space of the delivery locker 15 on the basis of the delivery locker delivery request information. The deliverer transmits a delivery locker delivery completion notification for notification of completion of item delivery to the delivery locker 15 to the delivery company server 11 using the deliverer terminal 14, as illustrated in FIG. 8 or FIG. 9. The delivery locker delivery completion notification may include, for example, the item ID of the item that is the target, the locker ID of the delivery locker 15 keeping the item, and a number of the storage space (hereinafter referred to as a locker number) in which the item is stored.

The communication unit 102 of the delivery company server 11 receives the delivery locker delivery completion notification and provides it to the communication controller 113.

In step S4, the delivery company server 11 notifies a delivery locker company of a user password.

Specifically, the password generator 112 generates the user password used for the user to receive the item in the delivery locker 15. The delivery manager 111 generates user password information. The user password information may include, for example, the user password, the locker ID of the delivery locker 15 on which the user password is set, and the locker number. The communication unit 102 transmits the user password information to the delivery locker server 12 under the control of the communication controller 113.

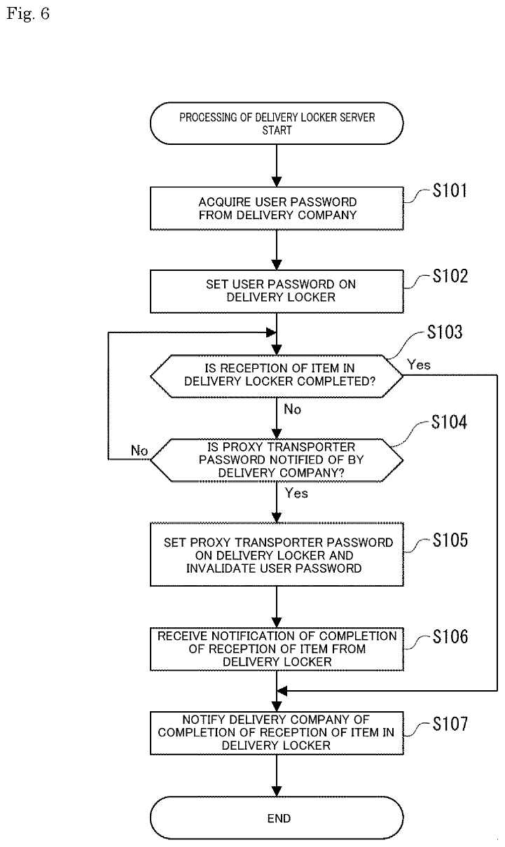

The delivery locker server 12 receives the user password information in step S101 of FIG. 6 which will be described later and sets the user password on the delivery locker 15 in step S102.

In step S5, the delivery company server 11 transmits user reception information to the user.

Specifically, the delivery manager 111 generates the user reception information. The user reception information may include, for example, the item ID of the item that is the target, the position of the delivery locker 15 keeping the item, the user password, and a period for which the item in the delivery locker 15 can be received (hereinafter referred to as a receivable period). The communication unit 102 transmits the user reception information to the user terminal 17 of the user under the control of the communication controller 113.

Accordingly, the user can acquire the user password and receive the item in the delivery locker 15.

In step S6, the delivery manager 111 determines whether reception of the item in the delivery locker 15 is completed. The delivery manager 111 determines that reception of the item in the delivery locker 15 is not completed when the reception completion notification has not been received from the delivery locker server 12, and processing proceeds to step S7.

In step S7, the delivery manager 111 determines whether the receivable period has elapsed. When it is determined that the receivable period has not yet elapsed, processing proceeds to step S8.

In step S8, the delivery manager 111 determines whether the user has requested proxy transportation. When a proxy transportation acceptance notification has not been received from the proxy transportation server 13, the delivery manager 111 determines that the user has not requested proxy transportation, and processing returns to step S6.

Thereafter, the processes of step S6 to step S8 are repeatedly executed until it is determined that reception of the item in the delivery locker 15 is completed in step S6, it is determined that the receivable period has elapsed in step S7, or it is determined that the user has requested proxy transportation in step S8.

On the other hand, when it is determined that the user has requested proxy transportation in step S8, processing proceeds to step S9.

For example, when the user requests proxy transportation by the proxy transportation company, the user may transmit proxy transportation request information to the proxy transportation server 13 using the user terminal 17, as illustrated in FIG. 8. The proxy transportation request information may include, for example, the item ID of the item that is the target, an address of a delivery destination, a time at which delivery is desired, and contact information of the user. Meanwhile, information about details of the item (e.g., the size, weight, type, and the like) may be included in the proxy transportation request information, for example.

Meanwhile, it is desirable that the time at which delivery is desired be able to be set more flexibly when the deliverer (delivery company) delivers the item to the user. For example, it is desirable that a time period other than a time period in which the deliverer can execute delivery be designatable (e.g., to 24 hours) or the unit of a designatable time be reduced (e.g., be in units of 30 minutes).

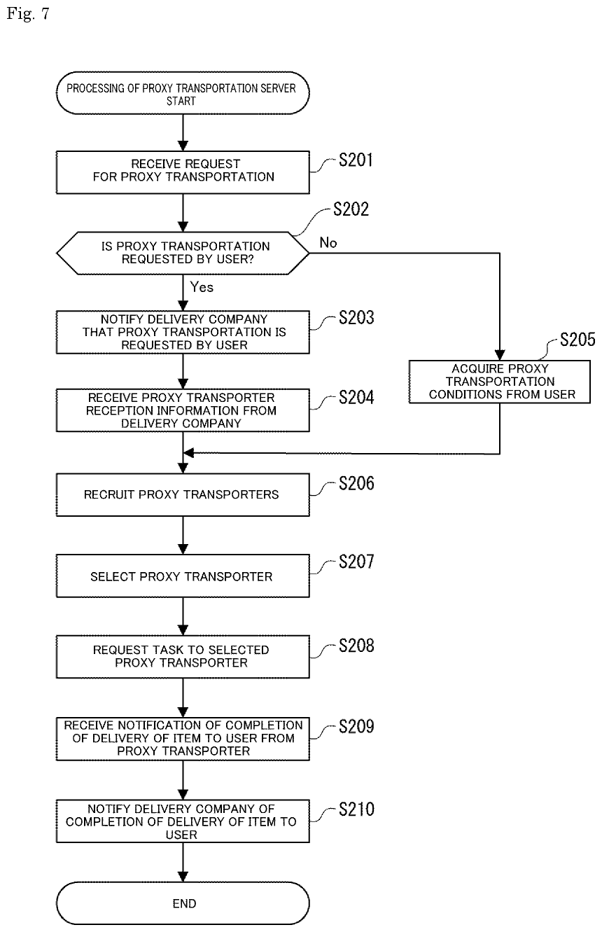

The proxy transportation server 13 receives the proxy transportation request information in step S201 of FIG. 7 which will be described later and transmits a proxy transportation acceptance notification for notification of acceptance of proxy transportation to the delivery company server 11 in step S203. The proxy transportation acceptance notification may include, for example, the item ID of the item that is the target, and the time at which delivery is desired.

The communication unit 102 of the delivery company server 11 receives the proxy transportation acceptance notification and provides it to the communication controller 113. Accordingly, the delivery manager 111 determines that the user has requested proxy transportation, and processing proceeds to step S9.

In step S9, the delivery company server 11 notifies the delivery locker company of a proxy transporter password.

Specifically, the password generator 112 generates the proxy transporter password used for a proxy transporter to receive the item in the delivery locker 15. The proxy transporter password is a password different from a user password, and a plurality of different passwords are generated for one item.

The delivery manager 111 generates proxy transporter password information. The proxy transporter password information may include, for example, the proxy transporter password, the locker ID of the delivery locker 15 on which the proxy transporter password is set, and the locker number. The communication unit 102 transmits the proxy transporter password information to the delivery locker server 12 under the control of the communication controller 113.

The delivery locker server 12 receives the proxy transporter password information in step S104 of FIG. 6 which will be described later, sets the proxy transporter password on the delivery locker 15 in step S105, and invalidates the user password.

In step S10, the delivery company server 11 transmits proxy transporter reception information to the proxy transportation company.

Specifically, the delivery manager 111 generates the proxy transporter reception information used for the proxy transporter to receive the item in the delivery locker 15. The proxy transporter reception information may include, for example, the item ID of the item that is the target, the locker ID of the delivery locker 15 in which the item is to be kept, and the proxy transporter password. The communication unit 102 transmits the proxy transporter reception information to the proxy transportation server 13 under the control of the communication controller 113.

The proxy transportation server 13 receives the proxy transporter reception information in step S204 of FIG. 7 which will be described later.

Thereafter, processing proceeds to step S14.

On the other hand, when it is determined that the receivable period has elapsed in step S7, processing proceeds to step S11. This is a case in which the receivable period has elapsed while the item is stored in the delivery locker 15 without being received by the user.

In step S11, the delivery locker company is notified of the proxy transporter password as in the process of step S9.

Accordingly, the proxy transporter password is set on the delivery locker 15 and the user password is invalidated.

In step S12, the delivery company server 11 requests proxy transportation by the proxy transportation company.

Specifically, the delivery manager 111 generates proxy transportation request information for requesting proxy transportation by the proxy transportation company. The proxy transportation request information may include, for example, the item ID of the item that is the target, the locker ID of the delivery locker 15 in which the item is to be kept, the proxy transporter password, the address of the delivery destination, and the contact information of the user. Meanwhile, information about details of the item (e.g., the size, weight, type, and the like) may be included in the proxy transportation request information, for example. The communication unit 102 transmits the proxy transportation request information to the proxy transportation server 13 under the control of the communication controller 113.

The proxy transportation server 13 receives the proxy transportation request information in step S201 of FIG. 7 which will be described later.

In step S13, the delivery company server 11 notifies the user that proxy transportation has been requested.

Specifically, the delivery manager 111 generates a proxy transportation request completion notification for notifying the user that proxy transportation has been requested. The proxy transportation request completion notification may include, for example, the item ID of the item that is the target, and contact information of the proxy transportation company. The communication unit 102 transmits a proxy transportation completion notification to the user terminal 17 of the user under the control of the communication controller 113.

Thereafter, processing proceeds to step S14.

In step S14, the delivery company server 11 receives a notification of completion of reception of the item in the delivery locker 15 from the delivery locker company.

Specifically, when the proxy transporter receives the item in the delivery locker 15, the delivery locker server 12 transmits a reception completion notification to the delivery company server 11 in step S107 of FIG. 6 which will be described later. The reception completion notification may include, for example, the locker ID and locker number of the delivery locker 15 from which the item has been received, the proxy transporter password used for reception, and a reception completion time.

The communication unit 102 of the delivery company server 11 receives the reception completion notification and provides it to the communication controller 113.

In step S15, the delivery company server 11 notifies the user of completion of reception of the item in the delivery locker 15.

Specifically, the delivery manager 111 generates the reception completion notification for notifying the user of completion of reception of the item in the delivery locker 15. The reception completion notification may include, for example, the item ID of the item that is the target, and the reception completion time. The communication unit 102 transmits the reception completion notification to the user terminal 17 of the user under the control of the communication controller 113.

In this manner, it is possible to reassure the user by notifying the user that the proxy transporter has received the item in the delivery locker 15.

In step S16, the delivery company server 11 receives a notification of completion of delivery of the item to the user from the proxy transportation company.

Specifically, when delivery of the item by the proxy transporter to the user is completed, the proxy transportation server 13 transmits a delivery completion notification to the delivery company server 11 in step S210 of FIG. 7 which will be described later. The delivery completion notification may include, for example, the item ID of the item that is the target, electronic data of a signature acquired from the user, and a delivery completion time.

The communication unit 102 of the delivery company server 11 receives the delivery completion notification and provides it to the communication controller 113.

Thereafter, processing of the delivery company server 11 ends.

On the other hand, when it is determined that reception of the item in the delivery locker 15 is completed in step S6, the processes of steps S7 to S16 are skipped and processing of the delivery company server 11 ends. This is a case in which the user has personally received the item in the delivery locker 15.

For example, when the user has received the item in the delivery locker 15, the delivery locker server 12 transmits a reception completion notification to the delivery company server 11 in step S107 of FIG. 6 which will be described later. The reception completion notification may include, for example, the locker ID and the locker number of the delivery locker 15 from which the item has been received, the user password used for reception, and a reception completion time.

The communication unit 102 of the delivery company server 11 receives the reception completion notification and provides it to the communication controller 113. Accordingly, the delivery manager 111 determines that reception of the item in the delivery locker 15 is completed, and processing of the delivery company server 11 ends.

<Processing of Delivery Locker Server 12>

Next, processing of the delivery locker server 12 executed in response to processing of the delivery company server 11 in FIG. 5 will be described with reference to the flowchart of FIG. 6 and the sequence diagrams of FIG. 8 and FIG. 9.

In step S101, the delivery locker server 12 acquires a user password from a delivery company.

Specifically, the communication unit 152 receives the user password information transmitted from the delivery company server 11 in the process of step S4 of FIG. 5 described above and provides the user password information to the communication controller 162.

In step S102, the delivery locker manager 161 sets the user password on the delivery locker 15. That is, the delivery locker manager 161 sets the user password on the delivery locker 15 in which the item of the user is stored through the communication controller 162 and the communication unit 152.

Accordingly, the item in the delivery locker 15 can be received using the user password.

In step S103, the delivery locker manager 161 determines whether reception of the item in the delivery locker 15 is completed. When a reception completion notification has not been received from the delivery locker 15, the delivery locker manager 161 determines that reception of the item in the delivery locker 15 is not completed, and processing proceeds to step S104.

In step S104, the delivery locker manager 161 determines whether a proxy transporter password has been notified by the delivery company. When proxy transporter password information has not been received from the delivery company server 11, the delivery locker manager 161 determines that the proxy transporter password has not been notified by the delivery company, and processing is returned to step S103.

Thereafter, the processes of steps S103 and S104 are repeatedly executed until it is determined that reception of the item in the delivery locker 15 is completed in step S103 or it is determined that the proxy transporter password has been notified by the delivery company in step S104.

On the other hand, when it is determined that the proxy transporter password has been notified by the delivery company in step S104, processing proceeds to step S105.

Specifically, when the communication unit 152 of the delivery locker server 12 receives the proxy transporter password information transmitted from the delivery company server 11 in the process of step S9 or step S11 of FIG. 5 described above, the communication unit 152 provides the proxy transporter password information to the communication controller 162. Accordingly, the delivery locker manager 161 determines that the proxy transporter password has been notified by the delivery company, and processing proceeds to step S105.

In step S105, the delivery locker manager 161 sets the proxy transporter password on the delivery locker 15 and invalidates the user password. That is, the delivery locker manager 161 sets the proxy transporter password on the delivery locker 15 in which the item of the user is stored through the communication controller 162 and the communication unit 152 and cancels setting of the user password.

Accordingly, reception of the item in the delivery locker 15 using the proxy transporter password can be performed and reception of the item in the delivery locker 15 using the user password cannot be performed. Therefore, the user is prevented from receiving the item in the delivery locker 15 irrespective of request for proxy transportation to the proxy transporter, for example. As a result, an opportunity of the proxy transporter for a work is prevented from being deprived or the proxy transporter is prevented from performing a useless work.

In addition, the delivery locker manager 161 can easily ascertain which one of the user and the proxy transporter has received the item by changing the user password and the proxy transporter password.

In step S106, the delivery locker server 12 receives a notification of completion of reception of the item from the delivery locker.

Specifically, when he proxy transporter has received the item from the delivery locker 15 using the proxy transporter password, the delivery locker 15 transmits a reception completion notification to the delivery locker server 12, as illustrated in FIG. 8 and FIG. 9. The reception completion notification includes the locker ID and the locker number of the delivery locker 15 from which the item has been received, the proxy transporter password used for reception, and a reception completion time.

The communication unit 152 of the delivery locker server 12 receives the reception completion notification and provides it to the communication controller 162.

Thereafter, processing proceeds to step S107.

On the other hand, when it is determined that reception of the item in the delivery locker 15 is completed in step S103, the processes of steps S104 to S106 are skipped and processing proceeds to step S107. This is a case in which the user has personally received the item from the delivery locker 15.

Specifically, when the user has received the item from the delivery locker 15 using the proxy transporter password, the delivery locker 15 transmits a reception completion notification to the delivery locker server 12. The reception completion notification includes the locker ID and the locker number of the delivery locker 15 from which the item has been received, the user password used for reception, and a reception completion time.

The communication unit 152 of the delivery locker server 12 receives the reception completion notification and provides it to the communication controller 162. Accordingly, the delivery locker manager 161 determines that reception of the item in the delivery locker 15 is completed, the processes of steps S104 to S106 are skipped, and processing proceeds to step S107.

In step S107, the delivery locker server 12 notifies the delivery company of completion of reception of the item from the delivery locker 15. For example, the communication unit 152 forwards the reception completion notification received from the delivery locker 15 to the delivery company server 11 under the control of the communication controller 162.

Thereafter, processing of the delivery locker server 12 ends.

<Processing of Proxy Transportation Server 13>

Next, processing of the proxy transportation server 13 executed in response to processing of the delivery company server 11 in FIG. 5 and processing of the delivery locker server 12 in FIG. 6 will be described with reference to the flowchart of FIG. 7 and the sequence diagrams of FIG. 8 and FIG. 9.

In step S201, the proxy transportation server 13 receives a proxy transportation request.

Specifically, the communication unit 202 receives the proxy transportation request information transmitted from the delivery company server 11 in the process of step S12 of FIG. 5 described above or the proxy transportation request information transmitted from the user terminal 17 as illustrated in FIG. 8 and provides it to the communication controller 212.

Meanwhile, the proxy transportation request information transmitted from the user terminal 17 may include, for example, the item ID of the item that is the target, the address of the delivery destination, a time at which delivery is desired, and the contact information of the user. Further, conditions (e.g., the gender, age, and the like) for a proxy transporter that the user desires may be included in the proxy transportation request information, for example.

In step S202, the proxy transportation manager 211 determines whether the user requests proxy transportation. When the proxy transportation request information is received from the user terminal 17, the proxy transportation manager 211 determines that the user requests proxy transportation, and processing proceeds to step S203.

In step S203, the proxy transportation server 13 notifies the delivery company that a proxy transportation request has been received from the user.

Specifically, the proxy transportation manager 211 generates a proxy transportation acceptance notification. The proxy transportation acceptance notification may include, for example, the item ID of the item that is the target, the address of the delivery destination, the time at which delivery is desired, and the contact information of the user. The communication unit 202 transmits the proxy transportation acceptance notification to the delivery company server 11 under the control of the communication controller 212.

In step S204, the communication unit 202 receives the proxy transporter reception information transmitted from the delivery company server 11 in the process of step S10 of FIG. 5 described above. The communication unit 202 provides the received proxy transporter reception information to the communication controller 212.

Thereafter, processing proceeds to step S206.

On the other hand, when the proxy transportation manager 211 receives the proxy transportation request information from the delivery company server 11 in step S202, the proxy transportation manager 211 determines that the delivery company requests proxy transportation, and processing proceeds to step S205.

In step S205, the proxy transportation server 13 acquires proxy transportation conditions from the user.

Specifically, when the user receives a proxy transportation request completion notification from the delivery company server 11, as illustrated in FIG. 9, the user transmits proxy transportation condition information to the proxy transportation server 13 using the user terminal 17. The proxy transportation condition information may include, for example, the item ID of the item that is the target, the address of the delivery destination, the time at which delivery is desired, and the contact information of the user. Meanwhile, conditions for a proxy transporter that the user desires may be included in the proxy transportation condition information, for example.

The communication unit 202 of the proxy transportation server 13 receives the proxy transportation condition information transmitted from the user terminal 17 and provides it to the communication controller 212.

Thereafter, processing proceeds to step S206.

In step S206, the proxy transportation server 13 recruits proxy transporters.

Specifically, the proxy transportation manager 211 generates proxy transportation recruitment information for recruiting proxy transporters. The proxy transportation recruitment information may include, for example, a task ID for identifying a task to be recruited, the position of the delivery locker 15 in which the item is stored, the area of the delivery destination, the time at which delivery is desired, a price, and the like. The communication unit 202 simultaneously distributes the proxy transportation recruitment information to the proxy transporter terminals 16 of respective proxy transporters under the control of the communication controller 212.

Meanwhile, information on each proxy transporter may be stored in the storage unit 203 in advance, for example. In addition, the proxy transportation manager 211 may distribute the proxy transportation recruitment information to all registered proxy transporters or to only proxy transporters corresponding to predetermined entry conditions, for example.

In the latter case, a current position of a proxy transporter, a past evaluation value of the proxy transporter, conditions desired by the user, and the like may be set as entry conditions, for example. Meanwhile, a past evaluation value of a proxy transporter may be, for example, an average value of evaluation values assigned by the user to past tasks of the proxy transporter.

In step S207, the proxy transportation server 13 selects a proxy transporter.

For example, when a proxy transporter applies for recruitment of proxy transporters, as illustrated in FIG. 8 or 9, the proxy transporter may transmit proxy transportation entry information to the proxy transportation server 13 using the proxy transporter terminal 16. The proxy transportation entry information may include, for example, a task ID and a proxy transporter ID for identifying a proxy transporter.

The communication unit 202 of the proxy transportation server 13 receives the proxy transportation entry information and provides it to the communication controller 212.

The proxy transportation manager 211 selects a proxy transporter to which a task will be requested from proxy transporters who apply for on the basis of predetermined conditions. For example, the proxy transportation manager 211 may select a proxy transporter who has applied for first or select a proxy transporter having highest eligibility for the entry conditions.

In step S208, the proxy transportation server 13 requests a task to the selected proxy transporter.

Specifically, the proxy transportation manager 211 generates task order information for requesting a task (proxy transportation) to the proxy transporter. The task order information may include, for example, a task ID, the item ID of the item that is the target, the position of the delivery locker 15 receiving the item, a proxy transporter password, the address of the delivery destination, and the contact information of the user. The communication unit 202 transmits the task order information to the proxy transporter terminal 16 of the selected proxy transporter under the control of the communication controller 212.

Accordingly, the proxy transporter can acquire the proxy transporter password and receive the item in the delivery locker 15.

In step S209, the proxy transportation server 13 receives a notification of completion of delivery of the item to the user from the proxy transporter.

For example, the proxy transporter who has received a request for the task from the proxy transportation company receives the item from the delivery locker 15 using the proxy transporter password. Here, a signature for certifying that the proxy transporter has received the item may or may not be input to the delivery locker 15.

Next, the proxy transporter delivers the item to the designated delivery destination at the designated time at which delivery is desired.

Meanwhile, the proxy transporter may deliver the item received from the delivery locker 15 without storing the item or store the item at his/her home first and then delivers the item to the delivery destination.

Meanwhile, if occurrence of security risk or the like is conceived when the proxy transporter takes the item home and stores it, a period for which the proxy transporter can receive the item may be limited, for example. For example, the period for which the proxy transporter can receive the item may be limited to a predetermined time before the time at which delivery is desired until the time at which delivery is desired. This predetermined time may be set to a time required from the delivery locker 15 to the delivery destination and a grace time added thereto, for example. Accordingly, the proxy deliverer is prevented from taking the item home or the like and storing it.

Next, the proxy transporter acquires the signature for certifying that the item has been received from the user. A method for acquiring the signature is arbitrary. For example, the user may input the signature to the proxy transporter terminal 16 through an electronic method. Alternatively, the user may write an analog signature such as a handwritten signature or a receipt stamp on predetermined paper, for example. In the latter case, for example, the analog signature may be converted into electronic signature data through imaging, scanning, or the like and input to the proxy transporter terminal 16.

Meanwhile, when the user requests proxy transportation, the user may pay a proxy transportation fee for the proxy transporter, for example. The fee paid by the user may be supplied from the proxy transporter to the proxy transportation company, for example, and some of the fee is paid by the proxy transportation company for the proxy transporter for proxy transportation.

On the other hand, when the delivery company requests proxy transportation, for example, the user may pay a proxy transportation fee for the delivery company. Then, some or all fee paid by the user are supplied from the delivery company to the proxy transportation company, and some thereof is paid by the proxy transportation company for the proxy transporter for proxy transportation. Meanwhile, the amount supplied from the delivery company to the proxy transportation company may be determined by the proxy transportation company, for example.

Next, the proxy transporter transmits a delivery completion notification to the proxy transportation server 13 using the proxy transporter terminal 16, as illustrated in FIG. 8 or FIG. 9. The delivery completion notification may include, for example, the task ID, the item ID of the item that is the target, electronic data of the signature of the user, and a delivery completion time.

The communication unit 202 of the proxy transportation server 13 receives the delivery completion notification and provides it to the communication controller 212.

In step S210, the proxy transportation server 13 notifies the delivery company of completion of delivery to the user.

Specifically, the proxy transportation manager 211 generates a delivery completion notification. The delivery completion notification may include, for example, the item ID of the item that is the target, electronic data of the signature of the user, and a delivery completion time. The communication unit 202 transmits the delivery completion notification to the delivery company server 11 under the control of the communication controller 212.

Thereafter, processing of the proxy transportation server 13 ends.

As described above, it is possible to realize the proxy transportation service safely.

For example, since a proxy transporter password different from a user password is issued, it is surely ascertained that a proxy transporter has received an item in the delivery locker 15.

In addition, tracking of an item after received from the delivery locker 15 becomes easy because the delivery company and a user are notified that a proxy transporter has received the item in the delivery locker 15.

Further, the delivery company can confirm that an item has been safely delivered to a user because electronic data of a signature acquired by a proxy transporter from the user is transmitted to the delivery company.

In addition, a user can receive an item from a proxy transporter at ease by designating desired conditions for the proxy transporter.

### 2. MODIFIED EXAMPLES

Hereinafter, modified examples of the above-described embodiment of the present technology.

Although an example of invalidating a user password set in advance when a proxy transporter password is set on the delivery locker 15 has been illustrated in the above description, both the passwords may be validated. Accordingly, both a user and a proxy transporter can receive an item in the delivery locker 15. In this case, when the user has received the item in the delivery locker 15, it is desirable that the delivery company server 11 or the delivery locker server 12 notify the proxy transporter terminal 16 that the user has received the item in the delivery locker 15, for example.

In addition, a proxy transportation fee may be changed according to conditions, for example.

For example, the fee may be changed according to weather. For example, the fee may be increased on a rainy or snowy day.

For example, the fee may be changed according to a time period in which delivery is desired. For example, the fee may be increased when delivery is performed at midnight or early in the morning, or urgent delivery is performed.

For example, the fee may be increased when a user designates a proxy transporter or designates desired conditions for a proxy transporter.

For example, the fee may be increased as an evaluation value of a proxy transporter increases.

Further, a user may be notified of information about a proxy transporter requested by the proxy transportation company. For example, the proxy transportation server 13 may transmit information about a requested proxy transporter (e.g., the name, age, gender, and the like) to the user terminal 17 of the user in advance. Accordingly, the user can ascertain information on the proxy transporter in advance and thus can receive an item at ease. In addition, the user may change proxy transporters after acquisition of the information on the proxy transporter, for example.

Further, information on proxy transporters may be open to a website such that a user can designate a proxy transporter, for example.

In addition, a user may be notified that a proxy transporter will arrive soon before the proxy transporter arrives, for example. For example, when the proxy transportation server 13 detects that a current position of the proxy transporter is within a predetermined distance from a delivery destination (e.g., user's home or the like) on the basis of position information of the proxy transporter terminal 16, the proxy transportation server 13 may transmit information representing an estimated time of arrival of the proxy transporter to the user terminal 17 of the user.

Further, the proxy transportation company may request a task to a proxy transporter at a time when a certain number of requests of the proxy transportation is collected, for example. In this case, it is desirable that the proxy transportation company collect tasks of proxy transportation of items stored in the same delivery locker 15 and request the collected tasks to a proxy transporter. Accordingly, the proxy transporter can efficiently perform proxy transportation tasks. In addition, motivation of the proxy transporter is improved.

Furthermore, apportionment of processing among the delivery company server 11, the delivery locker server 12 and the proxy transportation server 13 is not limited to the above-described examples and may be changed as necessary.

For example, the delivery locker server 12 may generate a user password and a proxy transporter password and notify the delivery company server 11 and the proxy transportation server 13 of the generated user password and proxy transporter password.

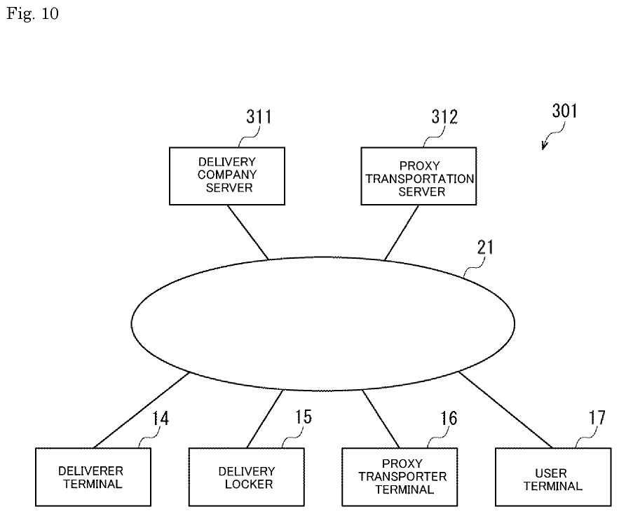

Further, the delivery locker server 12 may be deleted and only a delivery company server 311 and a proxy transportation server 312 may be installed, for example, as in a delivery system 301 of FIG. 10.

In this case, the functions of the delivery locker server 12 are installed in the delivery company server 311 or the proxy transportation server 312. When the functions of the delivery locker server 12 are installed in the delivery company server 311, for example, a delivery company may also provide the delivery locker service in addition to the delivery service. When the functions of the delivery locker server 12 are installed in the proxy transportation server 312, for example, a proxy transportation company may also provide the delivery locker service in addition to the proxy transportation service.

Meanwhile, the functions of the delivery locker server 12 may be shared by the delivery company server 311 and the proxy transportation server 312.

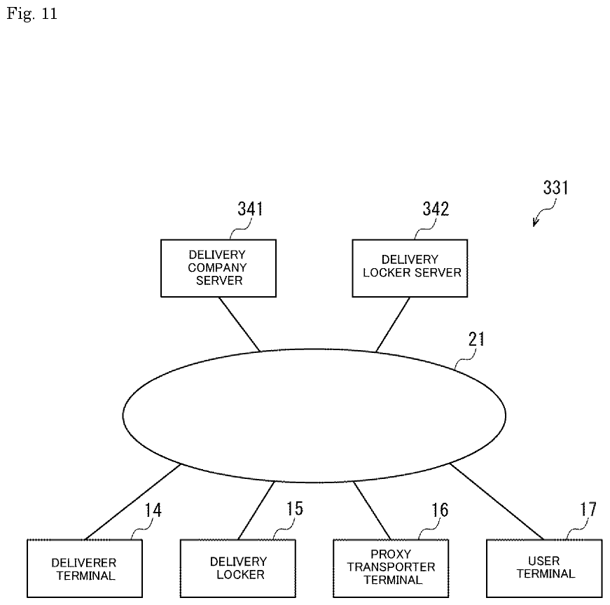

In addition, the proxy transportation server 13 may be deleted and only a delivery company server 341 and a delivery locker server 342 may be installed, for example, as in a delivery system 331 of FIG. 11.

In this case, the functions of the proxy transportation server 13 are installed in the delivery company server 341 or the delivery locker server 342. When the functions of the proxy transportation server 13 are installed in the delivery company server 341, for example, a delivery company may also provide the proxy transportation service in addition to the delivery service. When the functions of the proxy transportation server 13 are installed in the delivery locker server 342, for example, a delivery locker company may also provide the proxy transportation service in addition to the delivery locker service.

Meanwhile, the functions of the proxy transportation server 13 may be shared by the delivery company server 341 and the delivery locker server 342.

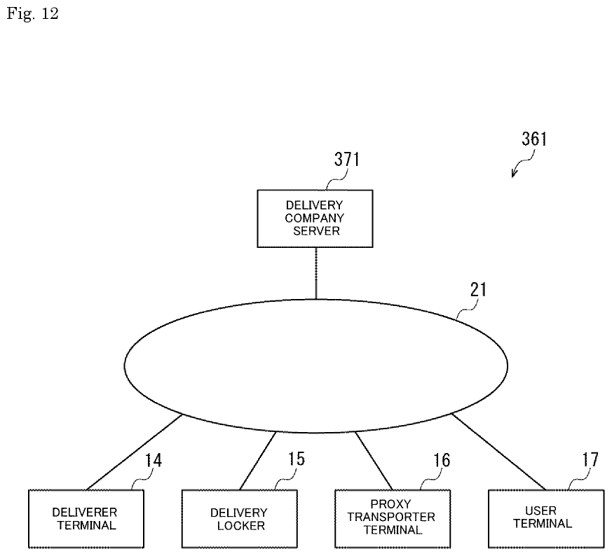

Further, the delivery locker server 12 and the proxy transportation server 13 may be deleted and only a delivery company server 371 may be installed, for example, as in a distribution system 361 of FIG. 12.

In this case, the functions of the delivery locker server 12 and the proxy transportation server 13 are installed in the delivery company server 371. In addition, a delivery company may also provide the delivery locker service and the proxy transportation service in addition to the delivery service, for example.

### 3. OTHERS

<Configuration Example of Computer>

The series of processes described above may be executed by hardware or may be executed by software. In the case where the series of processes is executed by software, a program that configures the software is installed on a computer. Here, the computer includes, for example, a computer built in dedicated hardware, a general-purpose personal computer on which various programs are installed to be able to execute various functions, and the like.

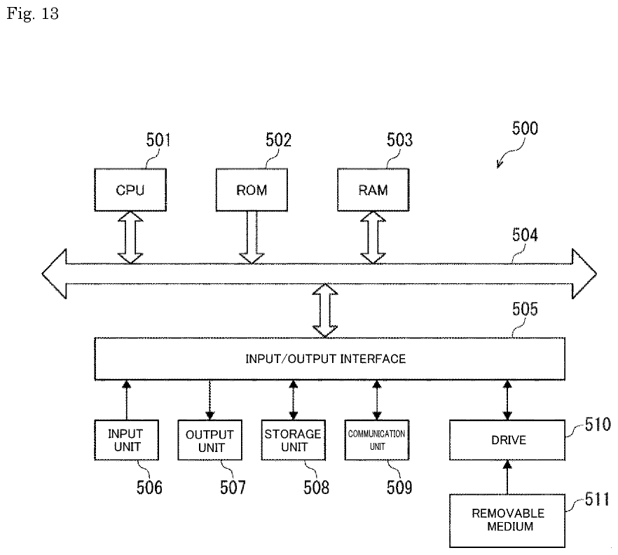

FIG. 13 is a block diagram illustrating an example of a hardware configuration of a computer that executes the series of processes described above according to a program.

In a computer 500, a central processing unit (CPU) 501, a read only memory (ROM) 502, and a random access memory (RAM) 503 are connected to each other via a bus 504.

An input/output interface 505 is also connected to the bus 504. An input unit 506, an output unit 507, a storage unit 508, a communication unit 509, and a drive 510 are connected to the input/output interface 505.

The input unit 506 includes an input switch, a button, a microphone, an imaging element, and the like. The output unit 507 includes a display, a speaker, and the like. The storage unit 508 includes a hard disk, a non-volatile memory, and the like. The communication unit 509 includes a network interface and the like. The drive 510 drives a removable medium 511 such as a magnetic disk, an optical disc, a magneto-optical disk, or a semiconductor memory.

In the computer 500 configured as described above, for example, the CPU 501 loads a program recorded in the storage unit 508 into the RAM 503 via the input/output interface 505 and the bus 504 and executes the program to perform the series of processes described above.

The program executed by the computer 500 (CPU 501) may be recorded on, for example, the removable medium 511 as a package medium or the like so as to be provided. Further, the program may also be provided via a wired or wireless transmission medium such as a local area network, the Internet, or digital satellite broadcasting.

In the computer 500, the program may be installed in the storage unit 508 via the input/output interface 505 by inserting the removable medium 511 into the drive 510. In addition, the program may be received through the communication unit 509 via a wired or wireless transmission medium and installed in the storage unit 508. In addition, this program may be installed in advance in the ROM 502 or the storage unit 508.

Meanwhile, the program executed by the computer may be a program through which processes are performed in a time series according to sequences described in the present description or a program through which processes are performed in parallel or at a necessary timing such as a timing at which calling is performed.

In addition, in the present description, the system means a set of a plurality of components (devices, modules (parts), etc.), and it does not matter whether or not all the components are arranged in a single housing. Therefore, a plurality of devices housed in separate housings and connected to each other via a network, and one device in which a plurality of modules housed in a single housing, are each referred to as the system.

Further, the embodiments of the present technology are not limited to the above-mentioned embodiments and can variously be changed within the range not departing from the gist of the present technology.

For example, the present technology may have a cloud computing configuration in which one function is shared with and processed by a plurality of devices via a network.

Further, the respective steps described in the above-described flowchart may be executed by one device or in a shared manner by a plurality of devices.

Furthermore, in the case where a plurality of kinds of processing are included in a single step, the plurality of kinds of processing included in the single step may be executed by one device or in a shared manner by a plurality of devices.

<Example of Combination of Configurations>

The present technology may also be configured as follows.

(1)

An information processing device including

a password generator configured to generate a plurality of different passwords for one item, the different passwords being passwords for receiving the item from a delivery locker.

(2)

The information processing device according to (1), wherein

the password generator generates a first password for a user and a second password for a proxy transporter that performs proxy transportation including receiving the item in the delivery locker and delivering the item to the user.

(3)

The information processing device according to (2), wherein the password generator generates the second password when the user requests the proxy transportation.

(4)

The information processing device according to (2) or (3), wherein the password generator generates the second password when a predetermined period has elapsed with the item stored in the delivery locker.

(5)

The information processing device according to any one of (2) to (4), further including

a communication unit configured to transmit the second password to a first information processing device that requests the proxy transportation by the proxy transporter.

(6)

The information processing device according to (5), wherein

the communication unit receives, from the first information processing device, electronic data of a signature acquired by the proxy transporter from the user.

(7)

The information processing device according to any one of (2) to (4), further including

a communication unit configured to transmit the second password to the proxy transporter.

(8)

The information processing device according to any one of (1) to (4), further including

a communication unit configured to transmit the plurality of passwords to a second information processing device that sets the passwords on the delivery locker.

(9)

The information processing device according to any one of (1) to (7), further including

a delivery locker manager configured to set the plurality of passwords on the delivery locker.

(10)

An information processing method including,

by an information processing device,

generating a plurality of different passwords for one item, the different passwords being passwords for receiving the item from a delivery locker.

(11)

A program for causing a computer to execute processing of

generating a plurality of different passwords for one item, the different passwords being passwords for receiving the item from a delivery locker.

(12)

An information processing device including

a delivery locker manager configured to set, on a delivery locker, a plurality of different passwords for one item, the different passwords being passwords for receiving the item.

(13)

The information processing device according to (12), wherein

the delivery locker manager sets, on the delivery locker, a first password for a user and a second password for a proxy transporter that performs proxy transportation including receiving the item in the delivery locker and delivering the item to the user.

(14)

The information processing device according to (13), wherein the delivery locker manager invalidates the first password when setting the second password in a case where the first password is set on the delivery locker.

(15)

The information processing device according to (13) or (14), further including a communication unit configured to transmit the second password to the proxy transporter.

(16)

The information processing device according to any one of (12) to (14), further including

a communication unit configured to receive the plurality of passwords from another information processing device that receives a request for reception of the item in the delivery locker from the user.

(17)

An information processing method including,

by an information processing device,

setting, on a delivery locker, a plurality of different passwords for one item, the different passwords being passwords for receiving the item.

(18)

A program for causing a computer to execute processing of

setting, on a delivery locker, a plurality of different passwords for one item, the different passwords being passwords for receiving the item.

(19)

An information processing device including

a communication unit configured to transmit a second password that is different from a first password for a user to receive an item in a delivery locker to a proxy transporter that performs proxy transportation including receiving the item in the delivery locker and delivering the item to the user.

(20)

The information processing device according to (19), wherein

the communication unit receives the second password from another information processing device that receives a request for reception of the item in the delivery locker from the user.

(21)

The information processing device according to (20), wherein

the communication unit transmits, to the other information processing device, electronic data of a signature acquired by the proxy transporter from the user.

(22)

The information processing device according to any one of (19) to (21), further including

a proxy transportation manager configured to generate recruitment information for the proxy transporter, wherein

the communication unit transmits the recruitment information to a plurality of proxy transporters and receives entry information for the recruitment information.

(23)

The information processing device according to (22), wherein

the proxy transportation manager selects the proxy transporter to which the proxy transportation will be requested from the proxy transporters that have entered, and

the communication unit transmits the second password to the selected proxy transporter.

(24)

An information processing method including,

by an information processing device,

transmitting a second password that is different from a first password for a user to receive an item in a delivery locker to a proxy transporter that performs proxy transportation including receiving the item in the delivery locker and delivering the item to the user.

(25)

A program for causing a computer to execute processing of

transmitting a second password that is different from a first password for a user to receive an item in a delivery locker to a proxy transporter that performs proxy transportation including receiving the item in the delivery locker and delivering the item to the user.

(26)

An information processing system including:

a password generator configured to generate a first password for a user to receive an item in a delivery locker and a second password for a proxy transporter that performs proxy transportation including receiving the item in the delivery locker and delivering the item to the user,

a delivery locker manager configured to set the first password and the second password on the delivery locker; and

a communication unit configured to transmit the second password to the proxy transporter.

The effects described herein are merely illustrative and not limitative, and other effects may be obtained.

### REFERENCE SIGN LIST

1 Delivery system
11 Delivery company server
12 Delivery locker server
13 Proxy transportation server
14 Deliverer terminal
15 Delivery locker
16 Proxy deliverer terminal
17 User terminal
101 Information processing unit
102 Communication unit
111 Delivery manager
112 Password generator
113 Communication controller
151 Information processing unit
152 Communication unit
161 Delivery locker manager
162 Communication controller
201 Information processing unit
202 Communication unit
211 Proxy transportation manager
212 Communication controller
301 Delivery system
311 Delivery company server
312 Proxy transportation server
331 Delivery system
341 Delivery company server
342 Delivery locker server
361 Delivery system
371 Delivery company server

1. An information processing device comprising
a password generator configured to generate a plurality of different passwords for one item, the different passwords being passwords for receiving the item from a delivery locker.

2. The information processing device according to claim 1, wherein
the password generator generates a first password for a user and a second password for a proxy transporter that performs proxy transportation including receiving the item in the delivery locker and delivering the item to the user.

3. The information processing device according to claim 2, wherein
the password generator generates the second password when the user requests the proxy transportation.

4. The information processing device according to claim 2, wherein
the password generator generates the second password when a predetermined period has elapsed with the item stored in the delivery locker.

5. The information processing device according to claim 2, further comprising
a communication unit configured to transmit the second password to a first information processing device that requests the proxy transportation by the proxy transporter.

6. The information processing device according to claim 5, wherein
the communication unit receives, from the first information processing device, electronic data of a signature acquired by the proxy transporter from the user.

7. The information processing device according to claim 2, further comprising
a communication unit configured to transmit the second password to the proxy transporter.

8. The information processing device according to claim 1, further comprising
a communication unit configured to transmit the plurality of passwords to a second information processing device that sets the passwords on the delivery locker.

9. The information processing device according to claim 1, further comprising
a delivery locker manager configured to set the plurality of passwords on the delivery locker.

10. An information processing method comprising,
by an information processing device,
generating a plurality of different passwords for one item, the different passwords being passwords for receiving the item from a delivery locker.

11. A program for causing a computer to execute processing of
generating a plurality of different passwords for one item, the different passwords being passwords for receiving the item from a delivery locker.

12. An information processing device comprising
a delivery locker manager configured to set, on a delivery locker, a plurality of different passwords for one item, the different passwords being passwords for receiving the item.

13. The information processing device according to claim 12, wherein
the delivery locker manager sets, on the delivery locker, a first password for a user and a second password for a proxy transporter that performs proxy transportation including receiving the item in the delivery locker and delivering the item to the user.

14. The information processing device according to claim 13, wherein
the delivery locker manager invalidates the first password when setting the second password in a case where the first password is set on the delivery locker.

15. The information processing device according to claim 13, further comprising
a communication unit configured to transmit the second password to the proxy transporter.

16. The information processing device according to claim 12, further comprising
a communication unit configured to receive the plurality of passwords from another information processing device that receives a request for reception of the item in the delivery locker from the user.

17. An information processing method comprising,
by an information processing device,
setting, on a delivery locker, a plurality of different passwords for one item, the different passwords being passwords for receiving the item.

18. A program for causing a computer to execute processing of
setting, on a delivery locker, a plurality of different passwords for one item, the different passwords being passwords for receiving the item.

19. An information processing device comprising
a communication unit configured to transmit a second password that is different from a first password for a user to receive an item in a delivery locker to a proxy transporter that performs proxy transportation including receiving the item in the delivery locker and delivering the item to the user.

20. The information processing device according to claim 19, wherein
the communication unit receives the second password from another information processing device that receives a request for reception of the item in the delivery locker from the user.

21. The information processing device according to claim 20, wherein
the communication unit transmits, to the other information processing device, electronic data of a signature acquired by the proxy transporter from the user.

22. The information processing device according to claim 19, further comprising
a proxy transportation manager configured to generate recruitment information for the proxy transporter, wherein
the communication unit transmits the recruitment information to a plurality of proxy transporters and receives entry information for the recruitment information.

23. The information processing device according to claim 22, wherein
the proxy transportation manager selects the proxy transporter to which the proxy transportation will be requested from the proxy transporters that have entered, and
the communication unit transmits the second password to the selected proxy transporter.

24. An information processing method comprising,
by an information processing device,
transmitting a second password that is different from a first password for a user to receive an item in a delivery locker to a proxy transporter that performs proxy transportation including receiving the item in the delivery locker and delivering the item to the user.

25. A program for causing a computer to execute processing of
transmitting a second password that is different from a first password for a user to receive an item in a delivery locker to a proxy transporter that performs proxy transportation including receiving the item in the delivery locker and delivering the item to the user.

26. An information processing system comprising:
a password generator configured to generate a first password for a user to receive an item in a delivery locker and a second password for a proxy transporter that performs proxy transportation including receiving the item in the delivery locker and delivering the item to the user;
a delivery locker manager configured to set the first password and the second password on the delivery locker; and
a communication unit configured to transmit the second password to the proxy transporter.
